(19) United States
(12) Patent Application Publication
(10) Pub. No.: US 2009/0251474 A1
(43) Pub. Date: Oct. 8, 2009

(54) VIRTUAL COMPUTING AND DISPLAY SYSTEM AND METHOD

(76) Inventors: Deanna J. Chou, Durham, NC (US); Jesse E. Craig, South Burlington, VT (US); Pascal A. Nsame, Essex Junction, VT (US); John Sargis, JR., Essex, VT (US); Daneyand J. Singley, Williston, VT (US); Sebastian T. Ventrone, South Burlington, VT (US)

Correspondence Address: CANTOR COLBURN LLP-IBM BURLINGTON, 20 Church Street, 22nd Floor, Hartford, CT, 06103, US

(21) Appl. No.: 12/099,183

(22) Filed: Apr. 8, 2008

(51) Int. Cl. G06T 1/00

(52) U.S. Cl. 345/522

(57) ABSTRACT

A virtual computing and display system and method. The system includes a plurality of microprocessor-based devices which run software applications, and each microprocessor-based device generates at least one graphic processing unit command stream including a packet of graphic commands. The system further includes at least one communication network which directly receives the graphics processing unit command stream from each of the microprocessor-based devices and transfers each of the generated graphics processing unit command streams via a respective active channel, at least one multi-core adaptive display server which receives and processes the graphics processing unit command streams, and at least one display which receives the packets via the at least one active channel per user session and displays at least one image. The at least one active channel connects a respective microprocessor-based device, the communication network, the at least one multi-core adaptive display server and the at least one display.

### BACKGROUND OF THE INVENTION

1. Field of the Invention

This invention relates to a system and method for optimizing computation and display for multiprocessor systems such as gaming and high performance applications using packetized atomic graphic commands and adaptive server hardware. Specifically, the present invention relates to a virtual computing and display system and a method of controlling the virtual computing and display system.

2. Description of Background

Currently, there are many multi-core implementations increasing in several applications and multi-processor systems such as, XBox 360, BlueGene, Playstation 3, and NVIDIA Scalable Link Interface (SLI). Typically, as shown in FIG. 1, the system 1 includes two subsystems, where one remote central processing unit (CPU) 1 shares a Graphics Processing Unit (GPU) with a second CPU 2 which is physically connected to the GPU subsystem. The CPU 1 initiates a remote procedure call (RPC) to CPU 2 in order to use the GPU 15 subsystem via a chip-to-chip network 10, and to display data on a Display #1 through n via Analog/DVI channels. The communication between CPU 1 and the GPU subsystem takes place through CPU 2 since CPU 2, which is the controlling CPU, is physically connected to the Displays #1 through #n, for example. The CPU 1 and CPU 2 may be either connected directly to one another or through a network connection. However, only one of the two CPUs, either CPU 1 or CPU 2, in this case CPU 2 has a physical connection with the Displays #1 through #n.

Many problems may occur in the current multi-processor systems when multiple users are involved. Scaling the display and compute bandwidth in the multi-processor system is limited. Further, the system runs into a bottleneck at CPU 2 (as shown in FIG. 1) and with the GPU 15 itself. Therefore, there is a problem in that it is difficult for more than one user to share the same display. This type of system is only efficient when one user is involved. Thus, as additional users are added, using the same display, the performance of the system 1 is impacted. Thus, it is necessary to have a system which enables multiple users to share the same environment while not significantly impacting the performance of the system.

### SUMMARY OF THE INVENTION

The shortcomings of the prior art are overcome and additional advantages are provided through the provision of a virtual computing and display (VCD) system comprising a plurality of microprocessor based devices which run software applications, and each microprocessor-based device generates at least one graphic processing unit command stream including a packet of graphic commands, at least one communication network which directly receives the GPU command stream from each of the microprocessor-based devices and transfers each of the generated GPU command streams via a respective active channel, at least one multi-core adaptive display server (ADS) which receives and processes the GPU command streams, and at least one display which receives the packets via the at least one active channel per user session and displays at least one image, the at least one active channel connects a respective microprocessor-based device, the at least one communication network, the at least one multi-core adaptive display server and the at least one display.

According to an exemplary embodiment of the present invention, the communication network comprises a hybrid network which inter-connects the plurality of microprocessor-based devices with the ADS to enable virtualized computing and display. The hybrid communication network comprises at least one of a wireless network, a wired network, a satellite network or a private network or any combination thereof.

A method and a computer program product corresponding to the above-summarized system is also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

Embodiments of the present invention create a system and method for optimizing a single multi-core GPU in a multi-core CPU system. That is, the present invention discloses a technique for creating, routing, and processing packetized atomic graphic commands (PAGC) through the system along a software pipeline from one integrated processing core to another in a multi-core system for the purposes of optimizing the computation and display. At any given time, the ADS of the present invention may have multiple graphic packets in various stages of processing. Atomic operations are useful in coordinating access to shared resources while low-latency inter-process communication mechanisms move packet information between pipeline stages and help control synchronization among processing cores. Local memory, caching, and coherency features results in lower internal latency, which is necessary to meet strict processing time constraints of each arriving packet.

As a result of the summarized invention, technically we have achieved a solution which enables multiple users to share the same environment while not significantly impacted the performance of a virtual computing and display system. Further, the system of the present invention can be easily integrated into cell products, reduces implementing costs of custom graphics subsystems, improves the quality of viewing images on the display(s) of the system, and also enables collaboration between distributed project teams.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram illustrating a conventional example of a virtual computing and display system.

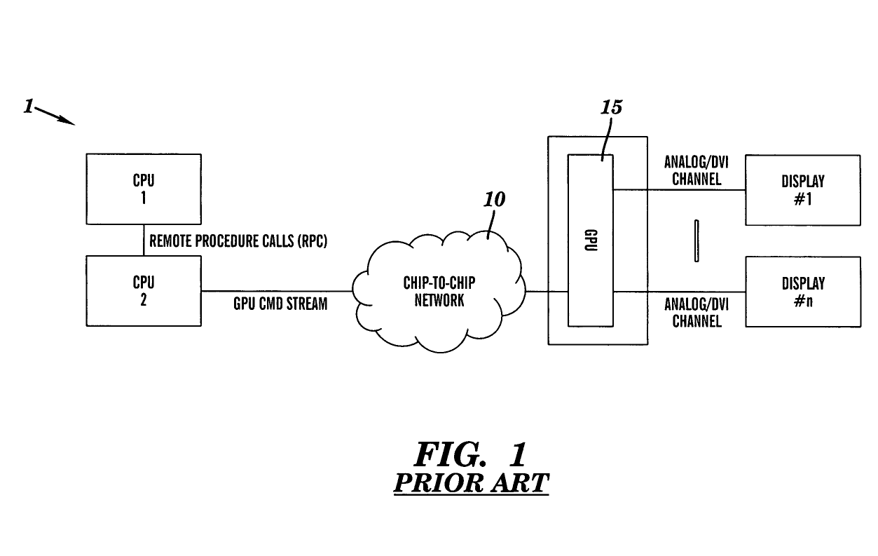

FIG. 2 is a schematic diagram illustrating a virtual computing and display (VCD) system that can be implemented within aspects of the present invention.

FIG. 3 is a diagram illustrating a packetized input GPU command stream used for processing by the adaptive display server (ADS) that can be implemented within embodiments of the present invention with reference to FIG. 2.

FIG. 4 is a schematic diagram illustrating a software view of the VCD system with an adaptive display server (ADS) that can be implemented within embodiments of the present invention.

FIG. 5 is a schematic diagram illustrating a hardware view of the VCD system with the ADS that can be implemented within embodiments of the present invention with reference to FIG. 4.

FIG. 6 is a schematic diagram illustrating a virtual computing and display (VCD) system having a hybrid network that can be implemented within another embodiment of the present invention.

FIG. 7 is a flowchart illustrating a method of controlling a virtual computing and display (VCD) system that can be implemented within embodiments of the present invention with reference to FIG. 4.

### DETAILED DESCRIPTION OF THE INVENTION

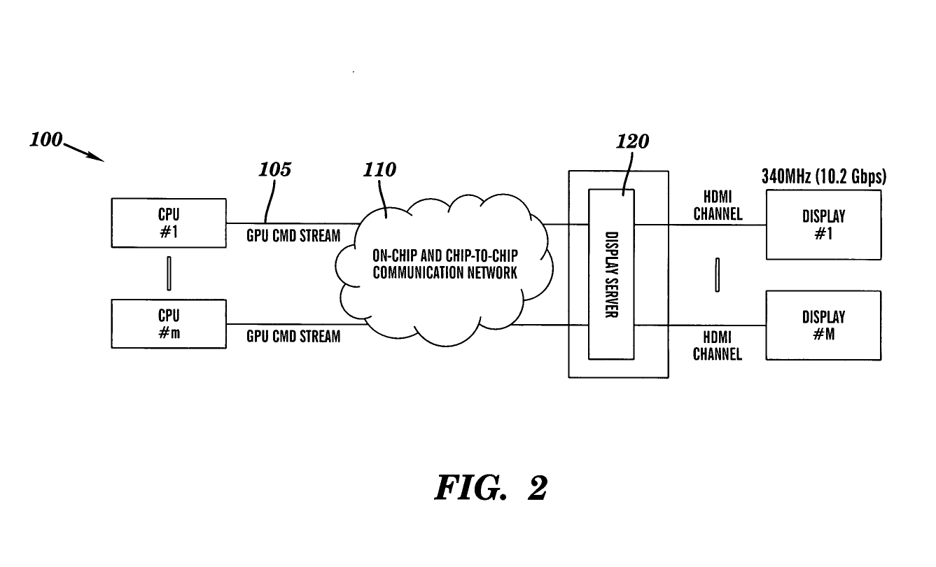

Turning now to the drawings in greater detail, it will be seen that in FIG. 2 there is a schematic diagram illustrating a virtual computing and display (VCD) system that can be implemented within aspects of the present invention.

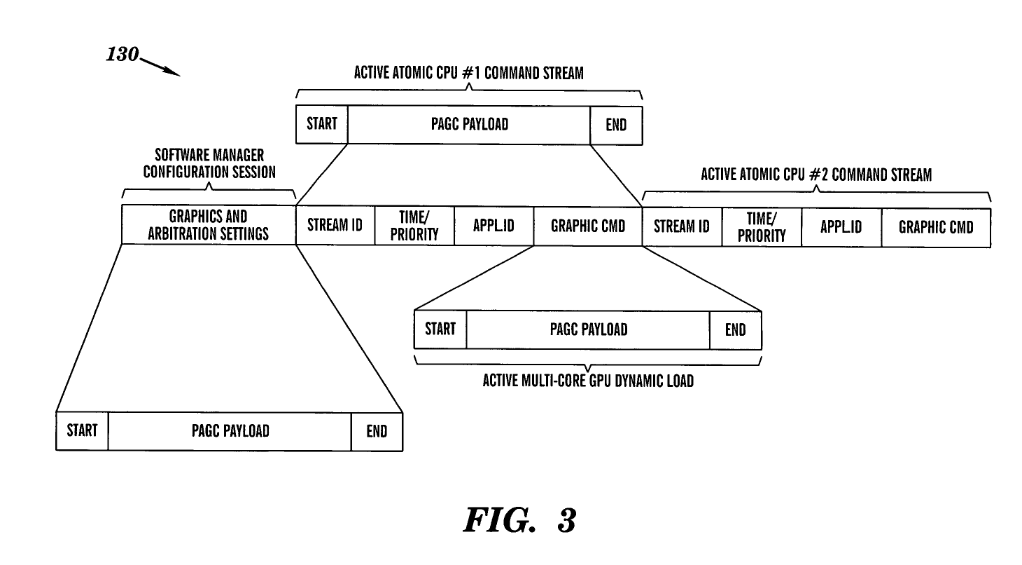

As shown in FIG. 2, a VCD system 100, according to an exemplary embodiment of the present invention, comprises a plurality of microprocessor-based devices, CPUs #1 through m which run software applications, and each of the microprocessor-based devices CPU #1 through m generates at least one GPU command stream including a packet 130 of graphic commands (see FIG. 3, for example). The present invention is not limited to a particular number of microprocessor-based devices and may vary, as necessary.

The VCD system 100 further comprises at least one communication network 110 which directly receives the GPU command stream from each of the microprocessor-based devices CPUs #1 through m, and transfers each of the generated GPU command streams via a respective active channel 105.

According to an exemplary embodiment, the VCD system 100 further comprises at least one ADS 120 which receives and processes the GPU command streams, and at least one display (Displays #1 through M) receives the packets via the at least one active channel 105 per user session and displays at least one image.

According to an exemplary embodiment, the at least one active channel 105 connects a respective microprocessor-based device CPUs #1 through m, the at least one communication network 110, the at least one ADS 120 and the at least one display (Displays #1 through M).

According to an exemplary embodiment, as shown in FIG. 2, a portion of the at least one active channel 105 which connects the ADS to the at least one display (Displays #1 through M) is a high-definition multi-media (HDMI) channel. The present invention is not limited to a particular number of ADSs or displays, and therefore, may vary as necessary.

In addition, according to an exemplary embodiment, the at least one communication network 110 comprises an on-chip and a chip-to-chip communication network (as shown in FIG. 2). However, the present invention is not limited hereto, and may vary as necessary.

FIG. 3 is a diagram illustrating a packetized input GPU command stream used for processing by the ADS 120 that can be implemented within embodiments of the present invention with reference to FIG. 2.

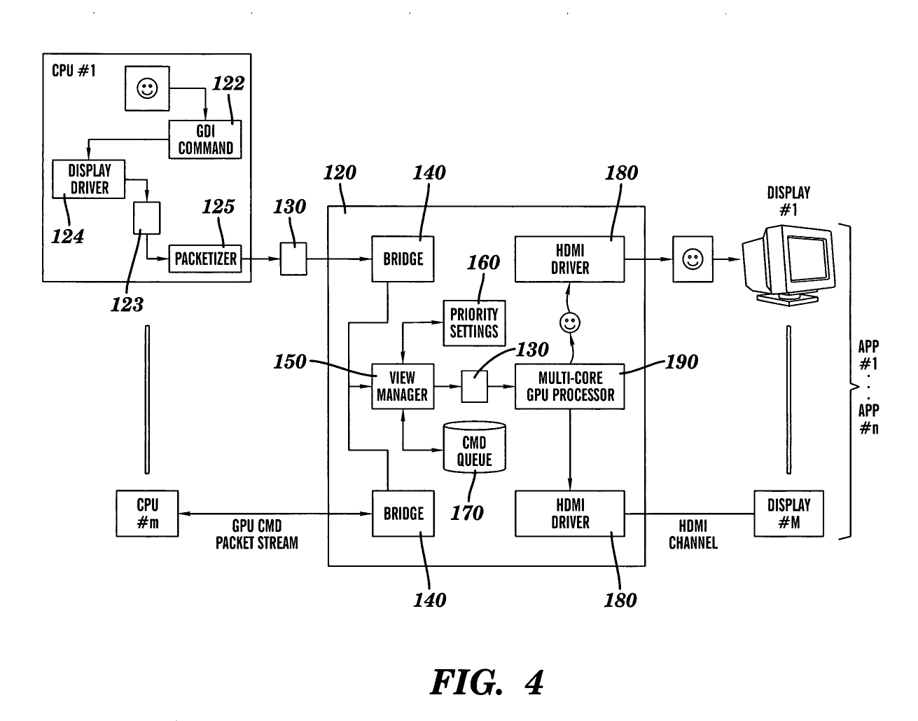

As shown in FIG. 3, each packet 130 comprises packetized atomic graphic commands (PAGC) which include a self-contained packet of a minimum set of graphic commands 123 (see FIG. 4) to be processed by the ADS 120.

Further, according to an exemplary embodiment, the minimum graphic commands 123 comprise at least one of translating drawing commands from one location of the display to another location on the display, scaling drawing commands, rotating drawing commands or any combination thereof.

Further, as shown in FIG. 3, each GPU command stream for each of the microprocessor-based devices CPUs #1 through m, for example, as shown for CPU #1 includes an associated source i.e., Stream ID, a type of service field i.e., Time/Priority associated with the respective packet 130, a destination i.e., an Application ID, and at least one graphic command 123.

FIG. 4 is a schematic diagram illustrating a software view of the VCD system 100 with the ADS 120 that can be implemented within embodiments of the present invention. Specifically, FIG. 4 provides detailed description with reference to the ADS 120 shown in FIG. 2, for example. However, the present invention is not limited hereto, and may vary as necessary.

As shown in FIG. 4, according to an exemplary embodiment of the present invention, the microprocessor-based devices CPUs 1 through m each run software applications. For example, as shown in FIG. 4, CPU #1 runs a software application which generates a service request for graphic resources, and the specified service request is then accepted via a graphics device interface (GDI) command 122. The GDI command 122 then generates graphic commands 123 to be sent to a display driver 124 of the respective microprocessor-based device CPU #1, for example. The graphics commands 123 are accepted at the display driver 124 and then forwarded to a packetizer 125 which generates a packet 130 of graphic commands 123 for the respective microprocessor-based device CPU #1. According to an exemplary embodiment, each of the microprocessor-based devices CPUs #1 through m perform these functions described above, in parallel and in real-time.

Further, as shown in FIG. 4, the ADS 120 comprises a plurality of bridges 140 which corresponds to a number of the microprocessor-based devices CPUs #1 through m and which acts as an interface with the number of the microprocessor-based devices CPUs #1 through m, and receives a packet 130 from each of the respective microprocessor-based devices CPUs #1 through m, in parallel and in real-time, to be processed. The ADS 120 further comprises a view manager unit 150 which receives the packets 130 from the respective bridges 140 and sets properties of the at least one image to be displayed on at least one display (Displays #1 through M).

According to an exemplary embodiment, the ADS 120, further comprises a priority settings unit 160 which receives the packets 130 from the view manager unit 150, and prioritizes the packets 130 and coordinates the packets 130, and a command queue 170 which holds information concerning how to prioritize the packets 130.

Further, the view manager unit 150 integrates multiple processing elements (PE) allocated to various functions within the view manager unit 150. Each receiving PE reads a GPU command stream from a respective active channel 105, assembles the packets 130 and places them in a reserved lane within the command queue 170. The receiving PE allocates sufficient buffers from a shared pool (not shown), while a traffic management PE returns the buffers, when a packet 130 is processed. A group of PEs removes the packets 130 from the command queue 170 and beings processing the contents of each packet 130. Referring to FIG. 3, the ADS 120 verifies the packet information and then classifies a PAGC payload (see FIG. 3, for example) by inspecting stream ID and the Application ID, the time and priority of the respective packets 130. According to an exemplary embodiment, an assigned PE calculates and updates the flow rate of the ADS 120. The software of the ADS 120 marks the packet 130 with a discard tag (not shown) based on whether it meets or exceeds the traffic constraints for a specified active channel 105. The software of the ADS 120 then checks the command queue 170 to determine its fullness and whether the packet 130 should be queued or dropped.

Now referring back to FIG. 4, according to an exemplary embodiment, the ADS 120, further comprises a multi-core GPU processor 190 which receives the packets 130 from the view manager unit 150 and performs graphics operations at a predetermined time based on a number of users of the system 100. The priority setting unit 160 schedules transmission to the multi-core GPU processor 190. Traffic management strategies and algorithms vary, as necessary. According to an exemplary embodiment, a hierarchical scheduling of the packets 130 is used. Therefore, different scheduling algorithms are used based on the number of lands in the command queue 170. The present invention is not limited to any particular type of scheduling algorithm and may vary, as necessary.

According to an exemplary embodiment, the ADS 120 further comprises a high definition multimedia interface (HDMI) driver which corresponds to each display (Displays #1 through M), and which formats and refreshes the displays (Displays #1 through M). An image is received via the HDMI Driver and transferred to at least one of the displays (Displays #1 through M).

According to an exemplary embodiment, the packets 130 are merged into one image to form a composite image to be displayed one display (Displays #1 through M) and all of the remaining displays are in an off-state. Alternatively, according to another exemplary embodiment, one display out of the Displays #1 through M is shared by all of the microprocessor-based devices CPUs #1 through m.

According to still another exemplary embodiment, the at least one image is partitioned across multiple displays (Displays #1 through M).

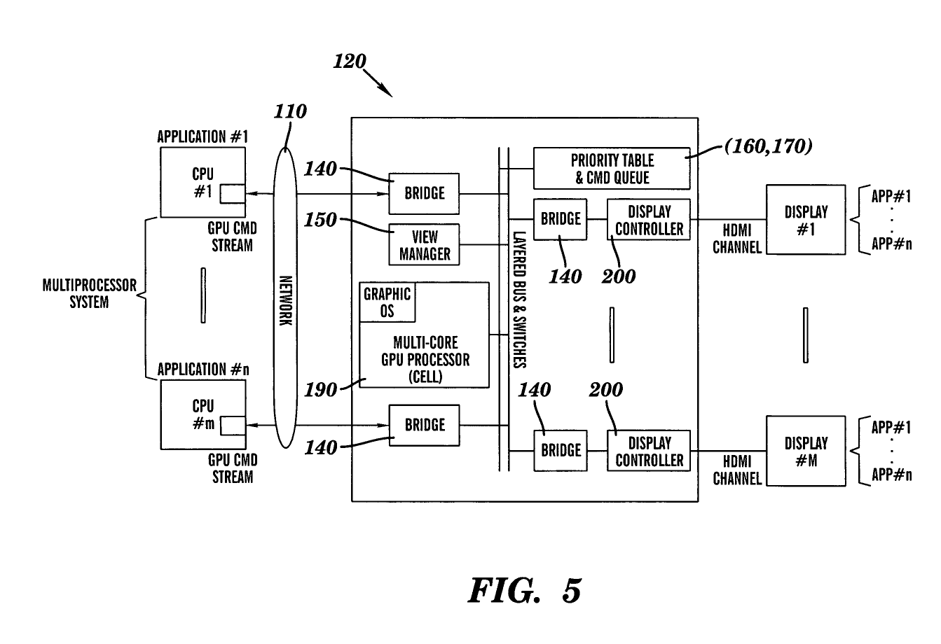

FIG. 5 is a schematic diagram illustrating a hardware view of the VCD system 100 with the ADS 120 that can be implemented within embodiments of the present invention with reference to FIG. 4.

Specifically, FIG. 5 illustrates the hardware view of the VCD system 100 shown in FIG. 4 (i.e., the software view of the VCD system 100). Therefore, some of the features of present invention as illustrated in FIG. 5 are the same as the features illustrated in FIG. 4, thus, a detailed description of these features have been omitted herein with reference to FIG. 5.

As shown in FIG. 5, the ADS 120 further comprises a display controller 200 which corresponds to the at least one display (Displays #1 through M) and controls the respective displays (Displays #1 through M). Each display controller 200 receives a packet 130 from a respective bridge 140 and forwards the packet 130 to the respective display (Displays #1 through M) via a respective HDMI channel. Further, the bridges 140, the view manager unit 150, the multi-core GPU processor 190, the priority table 160 and the command queue 170 are all connected via a layered bus and switches (not shown).

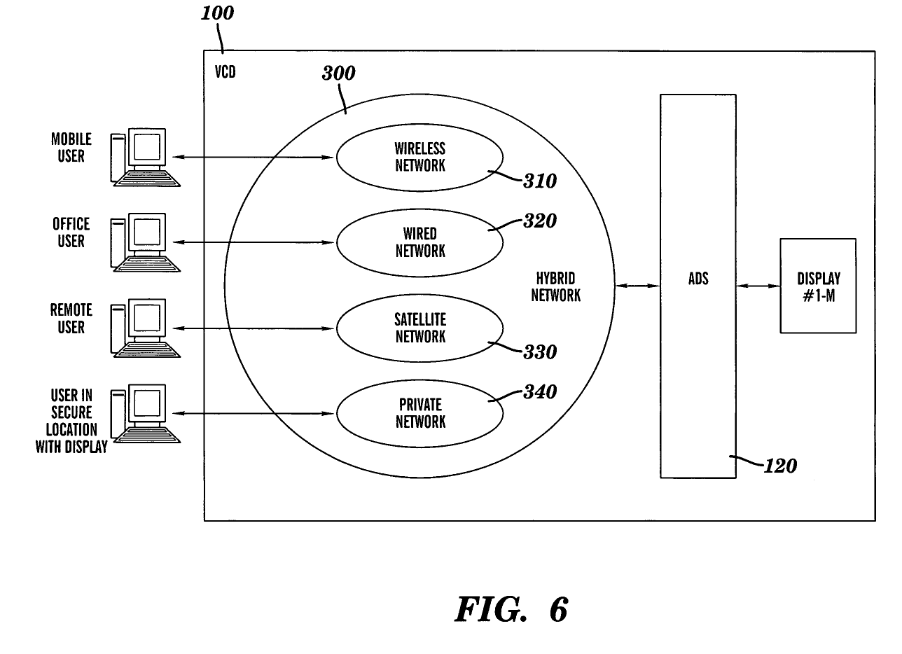

FIG. 6 is a schematic diagram illustrating a virtual computing display (VCD) system having a hybrid network that can be implemented within another embodiment of the present invention.

As shown in FIG. 6, the at least one communication network 110 (shown in FIG. 2) comprises a hybrid communication network 300 which inter-connects the plurality of microprocessor-based devices CPUs #1 through m, for example, a mobile user, an office user, a remote user and a user in a secure location with a display, with the ADS 120 in order to enable virtualized computing and displaying. As previously mentioned above, the present invention is not limited to any particular number of CPUs, and may vary as necessary. Further, as shown in FIG. 6, according to an exemplary embodiment, the hybrid communication network 300 comprises at least one of a wireless network 310, a wired network 320, a satellite network 330 or a private network 340 or any combination thereof. That is, the present invention is not limited to any particular combination of networks and may vary, accordingly. For example, the hybrid communication network may comprise a plurality of wireless networks 310, or a plurality of wired networks 320.

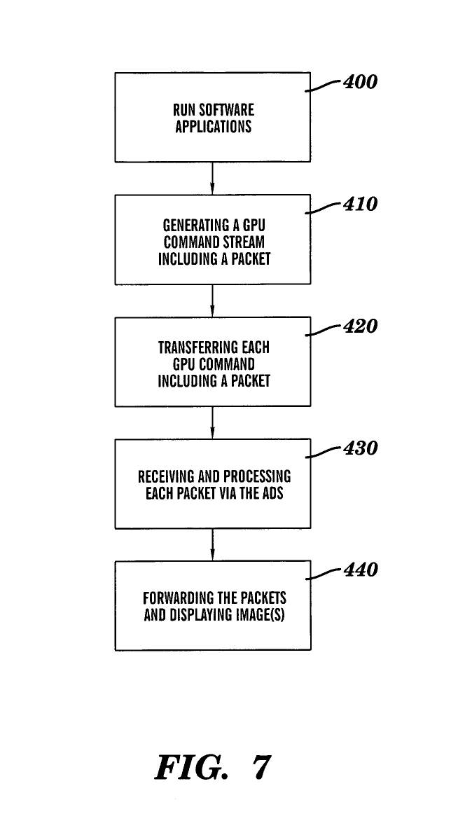

FIG. 7 is a flowchart illustrating a method of controlling the VCD system 100 that can be implemented within embodiments of the present invention with reference to FIG. 4.

Specifically, FIG. 7 is a flowchart which illustrates a method for controlling the VCD system 100 with reference to FIGS. 2 and 4, for example. The process begins at operation 400, where the plurality of microprocessor-based devices CPUs #1 through n run software applications. According to an exemplary embodiment, the running software applications via a plurality of microprocessor-based devices CPUs #1 through m, further comprises generating a service request for graphic resources via the software application (see CPU #1 for example shown in FIG. 4), accepting the service request for graphic resources via the GDI command 122, and generating graphic commands to be sent to the display driver 124 of the microprocessor-based device CPU #1, and then accepting the graphics commands at the display driver 124, and forwarding the graphics commands 123 to the packetizer 125 which generates a packet 130 of graphic commands for the respective microprocessor-based device CPU #1. This same process (i.e., operation 400) is performed for each of the microprocessor-based devices CPUs #1 through m, in parallel and in real-time.

From operation 400, the process moves to operation 410, where a GPU command stream which includes a packet of graphic commands 130 corresponding to each of the microprocessor-based devices CPUs #1 through m are generated. From operation 410, the process moves to operation 420 where these GPU command streams including the packets 130 are transferred over at least one communication network 110 (shown in FIG. 2) via at least one active channel 105.

From operation 420, the process moves to operation 430, where the ADS 120 receives the packets 130 from each of the microprocessor-based devices CPUs #1 through m, and processes the packets 130. Then from operation 430, the process moves to operation 440, where once the packets have been processed in the ADS 120, these packets are forwarded to at least one the displays 1 through M via the HDMI channels (see FIG. 2, for example) and at least one image is displayed on a display (Displays #1 through M).

According to still another exemplary embodiment, the process as shown in FIG. 7, may further comprises detecting and managing display events in a composite image, compacting and overlaying a focused window in a composite display memory, and associating the graphics commands in the packets 130 with an associated window identification number to enable digital processing of the composite image.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A virtual computing and display system, comprising:
a plurality of microprocessor-based devices which run software applications, and each microprocessor-based device generates at least one graphic processing unit command stream including a packet of graphic commands;
at least one communication network which directly receives the graphics processing unit command stream from each of the microprocessor-based devices and transfers each of the generated graphics processing unit command streams via a respective active channel;
at least one multi-core adaptive display server which receives and processes the graphics processing unit command streams; and
at least one display which receives the packets via the at least one active channel per user session and displays at least one image, the at least one active channel connects a respective microprocessor-based device, the at least one communication network, the at least one multi-core adaptive display server and the at least one display.

2. The virtual computing and display system of claim 1, wherein a portion of the at least one active channel which connects the at least one multi-core adaptive display server to the at least one display is a high-definition multi-media channel.

3. The virtual computing and display system of claim 1, wherein the at least one communication network comprises an on-chip and a chip-to-chip communication network.

4. The virtual computing and display system of claim 1, wherein the multi-core adaptive display server comprises:
a plurality of bridges which corresponds to a number of the microprocessor-based devices and which acts as an interface with the number of the microprocessor-based devices and receives a packet from each of the respective microprocessor-based devices in parallel and in real-time, to be processed;
a view manager unit which receives the packets from the respective bridges and sets properties of the at least one image to be displayed;
a priority settings unit which receives the packets from the view manager unit, and prioritizes and coordinates the packets;
a command queue which holds information concerning how to prioritize the packets;
a multi-core graphics processing unit which performs graphics operations at a predetermined time based on a number of users of the system; and
a high definition multimedia interface driver which formats and refreshes the at least one display.

5. The virtual computing and display system of claim 4, wherein the at least one multi-core adaptive display server further comprises a display controller which corresponds to the at least one display and controls the at least one display.

6. The virtual computing and display system of claim 1, wherein the at least one communication network comprises a hybrid communication network which inter-connects the plurality of microprocessor-based devices with the multi-core adaptive display server to enable virtualized computing and display.

7. The virtual computing and display system of claim 6, wherein the hybrid communication network comprises at least one of a wireless network, a wired network, a satellite network or a private network or any combination thereof.

8. The virtual computing and display system of claim 4, wherein the packets are merged into one image to form a composite image to be displayed one display and all other displays are in an off-state.

9. The virtual computing and display system of claim 1, wherein one display is shared by a total of the microprocessor-based devices.

10. The virtual computing and display system of claim 1, wherein the at least one image is partitioned across multiple displays.

11. The virtual computing and display system of claim 1, wherein the multi-core adaptive display server further comprises a packetizer which generates each packet including packetized atomic graphic commands which include a self-contained packet of a minimum set of graphic commands to be processed.

12. The virtual computing and display system of claim 11, wherein the minimum graphic commands comprise at least one of translating drawing commands from one location of the display to another location on the display, scaling drawing commands, rotating drawing commands or any combination thereof.

13. A method of controlling a virtual computing and display system, the method comprising:
running software applications via a plurality of microprocessor-based devices;
generating a graphics processing unit command stream which includes a packet of graphic commands, via each microprocessor-based device;
transferring each graphics processing unit command stream including the packet over at least one communication network via at least one active channel;
receiving and processing the packets, via at least one multi-core adaptive display server; and
forwarding the packets to at least one display via the at least one active channel per user session and displaying at least one image, the at least one active channel connects to a respective microprocessor-based device, the at least one communication network, the at least one multi-core adaptive display server and the at least one display.

14. The method of controlling a virtual computing and display system of claim 13, wherein the running software applications via a plurality of microprocessor-based devices further comprises:
generating a service request for graphic resources via the software application of a respective microprocessor-based device;
accepting the service request for graphic resources and generating graphic commands; and
accepting the graphics commands via a display driver, and generating a packet of graphic commands for the respective microprocessor-based device.

15. The method of controlling a virtual computing and display system of claim 14, wherein each packet comprises packetized atomic graphic commands which include a self-contained packet of a minimum set of graphic commands to be processed.

16. The method of controlling a virtual computing and display system of claim 15, wherein the minimum graphic commands comprise at least one of translating drawing commands from one location of the display to another location on the display, scaling drawing commands, rotating drawing commands or any combination thereof.

17. The method of controlling a virtual computing and display system of claim 16, further comprising:
detecting and managing display events in a composite image;
compacting/overlaying a focused window in a composite display memory; and
associating the graphics commands with an associated window identification number to enable digital processing of the composite image.

18. A computer program product comprising a computer useable medium including a computer readable program, wherein the computer readable program when executed on a computer causes the computer to implement a method, the method comprising:
running software applications via a plurality of microprocessor-based devices;
generating a graphics processing unit command stream which includes a packet of graphic commands, via each microprocessor-based device;
transferring each graphics processing unit command stream including the packet over at least one communication network via at least one active channel;
receiving and processing the packets, via at least one multi-core adaptive display server; and
forwarding the packets to at least one display via the at least one active channel per user session and displaying at least one image, the at least one active channel connects to a respective microprocessor-based device, the at least one communication network, the at least one multi-core adaptive display server and the at least one display.

19. The computer program product of claim 18, wherein running software applications via a plurality of microprocessor-based devices further comprises:
generating a service request for graphic resources via the software application of a respective microprocessor-based device;
accepting the service request for graphic resources and generating graphic commands; and
accepting the graphics commands via a display driver, and generating a packet of graphic commands for the respective microprocessor-based device.

20. The computer product of claim 19, wherein each packet comprises packetized atomic graphic commands which include a self-contained packet of a minimum set of graphic commands to be processed, and the minimum graphic commands comprise at least one of translating drawing commands from one location of the display to another location on the display, scaling drawing commands, rotating drawing commands or any combination thereof.
